(19) United States
(12) Patent Application Publication
(10) Pub. No.: US 2023/0158671 A1
(43) Pub. Date: May 25, 2023

(54) INTELLIGENT OBSTACLE AVOIDANCE OF MULTI-AXIS ROBOT ARM

(71) Applicant: Cheng Uei Precision Industry Co., LTD., New Taipei City (TW)

(72) Inventors: PO TING LIN, Taipei City (TW); SHIH-WEI LIN, New Taipei City (TW); KUN-CHENG LI, New Taipei City (TW); CHANG-YUN YANG, New Taipei City (TW); PEI-FEN WU, New Taipei City (TW); SHUN-CHIEN LAN, New Taipei City (TW)

(21) Appl. No.: 17/837,021

(22) Filed: Jun. 9, 2022

(30) Foreign Application Priority Data
Nov. 19, 2021 (TW) 110143284

(51) Int. Cl. B25J 9/16; B25J 9/06; B25J 13/08

(52) U.S. Cl. CPC B25J 9/1666; B25J 9/1651; B25J 9/06; B25J 13/089

(57) ABSTRACT

A system for the intelligent obstacle avoidance of multi-axis robot arm includes a multi-axis robot arm and a host device. The multi-axis robot arm includes a plurality of knuckles and a plurality of connecting arms. The plurality of the connecting arms are alternately connected with the plurality of the knuckles. The host device is electrically connected with the multi-axis robot arm. The host device includes a database device, an operation control module and a signal transmission module. The database device, the operation control module and the signal transmission module are electrically connected. The signal transmission module transmits a control signal to the multi-axis robot arm for performing an optimum obstacle avoidance posture.

### CROSS-REFERENCE TO RELATED APPLICATION

The present application is based on, and claims priority from, Taiwan Patent Application No. 110143284, filed Nov. 19, 2021, the disclosure of which is hereby incorporated by reference herein in its entirety.

### BACKGROUND OF THE INVENTION

### 1. Field of the Invention

The present invention generally relates to an automation equipment technology field, and more particularly to an intelligent obstacle avoidance of multi-axis robot arm, and the intelligent obstacle avoidance of multi-axis robot arm is used to select an optimum obstacle avoidance method from a variety of obstacle avoidance methods.

### 2. The Related Art

With the development of automation technologies, a proportion of various industries that improve factory production efficiencies through robot arms has gradually increased. Nevertheless, during an operation process of the robot arms, there may be people or other obstacles existed within a working range of the robot arms due to emergencies or other factors. Collisions are easily caused between the people and the robot arms, or the collisions are easily caused between the other obstacles and the robot arms. Persons are easily injured, and the robot arms or other objects are easily damaged due to the collisions. In order to avoid the collisions, types of anti-collision safety technologies are able be divided into contact types and non-contact types.

The contact type of the anti-collision safety technologies is described as follows. In one situation, when the robot arm encounters a resistance force to make a working current of a motor exceeds a limit, the robot arm will stop being operated on account of the resistance force and the limit of the working current of the motor. In another situation, when the robot arm which is equipped with a pressure sensor, hits an obstacle, the pressure sensor will send out a signal to the robot arm, the robot arm will stop being operated.

The non-contact type of the anti-collision safety technologies is described as follows. When the robot arm executes a task, evaluate whether the robot arm will collide during an operation of the robot arm. If it is evaluated that the robot arm will collide, execute a step of finding an obstacle avoidance posture to avoid the obstacle by a pre-established database.

However, because in the contact type of the anti-collision safety technologies, after the robot arm must hit the obstacle, the robot arm will stop being operated, at the moment, the person has been already injured, the robot arm has been already damaged, or product damages have been already occurred. In the process of avoiding the obstacle in the non-contact type of the anti-collision safety technologies, because there are many methods to avoid the obstacle, an optimum method may be without being chosen, so a time loss is resulted in avoiding the obstacle, or the robot arm proceeds with an obstacle avoidance in a non-ideal way.

### SUMMARY OF THE INVENTION

An object of the present invention is to provide an intelligent obstacle avoidance of multi-axis robot arm used to select an optimum obstacle avoidance method from a variety of obstacle avoidance methods, and a method for the intelligent obstacle avoidance of multi-axis robot arm. The method for the intelligent obstacle avoidance of multi-axis robot arm is applied in a multi-axis robot arm. The multi-axis robot arm includes a plurality of rotational axes and a telescopic axis. Specific steps of the method for the intelligent obstacle avoidance of multi-axis robot arm are described hereinafter. Establish a database. The database includes working posture data and control variables of the multi-axis robot arm. Calculate feasible obstacle avoidance postures according to the database. Set parameters of each rotational axis and the telescopic axis which control an operation of the multi-axis robot arm. Select the optimum obstacle avoidance posture with the least time of the operation of the multi-axis robot arm from the feasible obstacle avoidance postures.

Another object of the present invention is to provide a system for an intelligent obstacle avoidance of multi-axis robot arm. The system for the intelligent obstacle avoidance of multi-axis robot arm includes a multi-axis robot arm and a host device. The multi-axis robot arm includes a plurality of knuckles and a plurality of connecting arms. The plurality of the connecting arms are alternately connected with the plurality of the knuckles. The plurality of the connecting arms have a telescopic module. The host device is electrically connected with the multi-axis robot arm. The host device includes a database device, an operation control module and a signal transmission module. The database device, the operation control module and the signal transmission module are electrically connected. The database is established to store working posture data and control variables of the multi-axis robot arm, the operation control module calculates feasible obstacle avoidance postures according to the database, the operation control module sets parameters of each of the knuckles and the connecting arms, the parameters control an operation of the multi-axis robot arm, the operation control module selects the optimum obstacle avoidance posture with the least time of the operation of the multi-axis robot arm from the feasible obstacle avoidance postures, and according to the optimum obstacle avoidance posture, the signal transmission module transmits a control signal to the multi-axis robot arm for performing the optimum obstacle avoidance posture.

Another object of the present invention is to provide a system for an intelligent obstacle avoidance of multi-axis robot arm. The system for the intelligent obstacle avoidance of multi-axis robot arm includes a multi-axis robot arm and a host device. The multi-axis robot arm includes a plurality of knuckles and a plurality of connecting arms. The plurality of the connecting arms are alternately connected with the plurality of the knuckles. The host device is electrically connected with the multi-axis robot arm. The host device includes a database device, an operation control module and a signal transmission module. The database device, the operation control module and the signal transmission module are electrically connected. When the multi-axis robot arm encounters an obstacle in a task execution process of the multi-axis robot arm, the multi-axis robot arm will be not only without breaking off a task on account of encountering the obstacle, but also preferably optimize an obstacle avoidance trajectory and obstacle avoidance postures, so that the task is able to be achieved more quickly.

As described above, the intelligent obstacle avoidance of multi-axis robot arm applies the method for the intelligent obstacle avoidance of multi-axis robot arm, and the system for the intelligent obstacle avoidance of multi-axis robot arm applies the method for the intelligent obstacle avoidance of multi-axis robot arm, the system for the intelligent obstacle avoidance of multi-axis robot arm pre-stores the possible postures of the multi-axis robot arm in the database of the database device. When the multi-axis robot arm is operated, whether a collision will occur is able to be quickly evaluated during a movement, so the method for the intelligent obstacle avoidance of multi-axis robot arm exactly reaches a purpose of the present invention. As a result, the intelligent obstacle avoidance of multi-axis robot arm is used to select the optimum obstacle avoidance method from the variety of the obstacle avoidance methods.

### BRIEF DESCRIPTION OF THE DRAWINGS

The present invention will be apparent to those skilled in the art by reading the following description, with reference to the attached drawings, in which:

FIG. 1 is a block diagram of a system for an intelligent obstacle avoidance of multi-axis robot arm in accordance with a preferred embodiment of the present invention;

FIG. 2 is a flow chart of a method for the intelligent obstacle avoidance of multi-axis robot arm in accordance with the preferred embodiment of the present invention;

FIG. 3 is a schematic diagram of a multi-axis robot arm in accordance with the preferred embodiment of the present invention, wherein the multi-axis robot arm moves along a trajectory, and the multi-axis robot arm encounters an obstacle;

FIG. 4 is a schematic diagram of the multi-axis robot arm in accordance with the preferred embodiment of the present invention, wherein the system for the intelligent obstacle avoidance of the multi-axis robot arm calculates the trajectory for the multi-axis robot arm to avoid the obstacle in accordance with the present invention;

FIG. 5 is a schematic diagram of the multi-axis robot arm in accordance with the preferred embodiment of the present invention, wherein the multi-axis robot arm chooses to control a telescopic axis to avoid the obstacle; and

FIG. 6 is a schematic diagram of the multi-axis robot arm in accordance with the preferred embodiment of the present invention, wherein the multi-axis robot arm chooses to control other rotational axes to avoid the obstacle.

### DETAILED DESCRIPTION OF THE PREFERRED EMBODIMENT

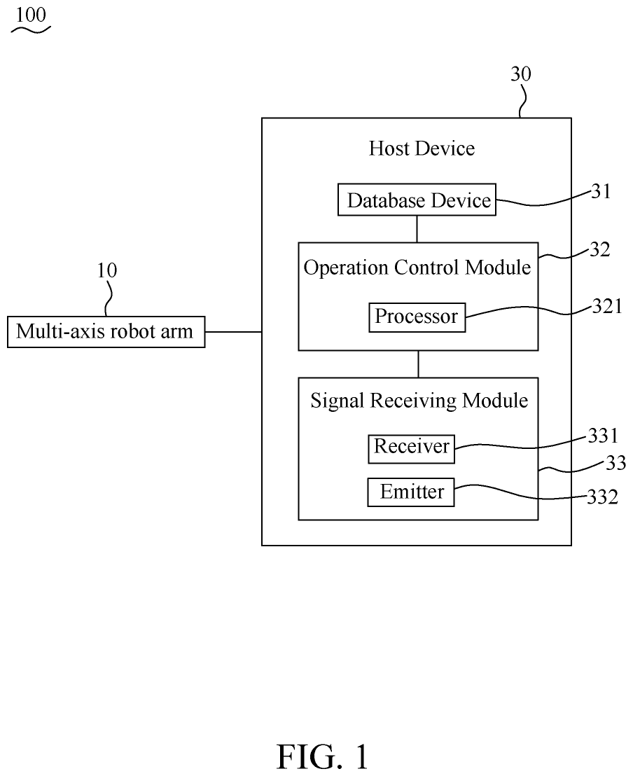

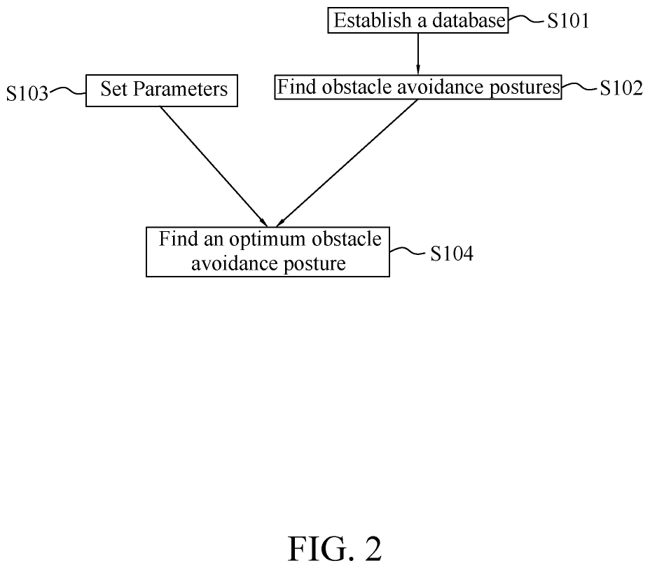

Referring to FIG. 1 to FIG. 5, an intelligent obstacle avoidance of multi-axis robot arm in accordance with a preferred embodiment of the present invention is shown. The intelligent obstacle avoidance of multi-axis robot arm is applied in a system 100 for the intelligent obstacle avoidance of multi-axis robot arm. The intelligent obstacle avoidance of multi-axis robot arm applies a method for the intelligent obstacle avoidance of multi-axis robot arm. The system 100 for the intelligent obstacle avoidance of multi-axis robot arm applies the method for the intelligent obstacle avoidance of multi-axis robot arm. The system 100 for the intelligent obstacle avoidance of multi-axis robot arm includes a multi-axis robot arm 10 with a high freedom degree, and a host device 30. The method for the intelligent obstacle avoidance of multi-axis robot arm is applied in the multi-axis robot arm 10 with the high freedom degree, and the host device 30. The host device 30 is electrically connected with the multi-axis robot arm 10. The multi-axis robot arm 10 includes a plurality of rotational axes and a telescopic axis.

In this preferred embodiment, the multi-axis robot arm 10 is fixed on a pedestal 20. The multi-axis robot arm 10 includes a plurality of the knuckles 11 and a plurality of the connecting arms 12. The plurality of the connecting arms 12 are alternately connected with the plurality of the knuckles 11. The plurality of the connecting arms 12 have a telescopic module which has various extension working postures and retraction working postures. The telescopic module is controlled by a motor.

The host device 30 includes a database device 31, an operation control module 32, a signal transmission module 33 and other elements (not shown). The database device 31, the operation control module 32, the signal transmission module 33 and the other elements are electrically connected.

The operation control module 32 includes a processor 321. The signal transmission module 33 includes a receiver 331 and an emitter 332. In practical applications, the host device 30 is able to be a robot controller, a server, a desktop computer, or a laptop, etc. An electrical connection way between the host device 30 and the multi-axis robot arm 10 is without being limited to a wireless signal transmission through the signal transmission module 33. The electrical connection way between the host device 30 and the multi-axis robot arm 10 is also able to select a wired mode to transmit the signals.

With reference to FIG. 1 to FIG. 5 again, specific steps of the method for the intelligent obstacle avoidance of multi-axis robot arm include a first step S101, a second step S102, a third step S103 and a fourth step S104. The first step S101, the second step S102, the third step S103 and the fourth step S104 are processed by the processor 321 of the operation control module 32 of the host device 30.

The first step S101: establish a database of the database device 31. The database of the database device 31 includes working posture data, control parameters and control variables of the multi-axis robot arm 10. The first step S101 further has an action of modularizing the multi-axis robot arm 10 in a strict condition, so that an enough buffer space is formed between the multi-axis robot arm 10 and an obstacle. The multi-axis robot arm 10 has various working postures in various working ranges. The first step S101 of establishing the database further has an action of marking the various working postures in the various working ranges as sampling points. Each sampling point has an own evaluation coordinate. The first step S101 of establishing the database further has an action of establishing a relative relationship between the evaluation coordinates and the working postures of the multi-axis robot arm 10 through the multiple evaluation coordinates.

The first step S101 further has an action of obtaining the control parameters and the control variables of the working postures of the multi-axis robot arm 10 on a trajectory of the multi-axis robot arm 10. The control variables and the control parameters are directly set via the host device 30 which is the robot controller, or calculate the control variables and the control parameters which are corresponding to axes of the multi-axis robot arm 10 from the known working postures and according to inverse kinematics. The control variables are calculated, the control variables are corresponding to the plurality of the rotational axes and the telescopic axis of the multi-axis robot arm 10 from the known working postures and according to the inverse kinematics. The first step S101 of establishing the database further has an action of judging whether space coordinates within the working range of the multi-axis robot arm 10 are partially occupied by the multi-axis robot arm 10. If the space coordinates within the working range of the multi-axis robot arm 10 are partially occupied by the multi-axis robot arm 10, the multi-axis robot arm 10 is judged to touch the obstacle, on the contrary, the multi-axis robot arm 10 is without touching the obstacle. The first step S101 further has an action of establishing the above data in advance for the use of a subsequent obstacle avoidance.

The second step S102: calculate feasible obstacle avoidance postures according to the database, specifically, find the obstacle avoidance postures according to the first step S101 of establishing the database of the database device 31 to calculate the feasible complex obstacle avoidance postures, and then select the optimum obstacle avoidance posture. According to a following equation:

Min (Xⁱnew-Xⁱ)²s.t. O (Xⁱnew)<=O_{T} (1)

The obstacle avoidance postures are able to be obtained. Xⁱnew is the control variable which is corresponding to the obstacle avoidance posture. For example, the control variable Xⁱ is able to a variation of each knuckle 11 which is controlled by the motor. O_{T} is a threshold value for evaluating whether the multi-axis robot arm 10 will touch the obstacle. When a value of O_{T} is smaller, a distance between the multi-axis robot arm 10 and the obstacle is larger, a probability of the multi-axis robot arm 10 touching the obstacle is lowered. The obstacle avoidance postures of the multi-axis robot arm 10 are able to be calculated through a variation of the minimum control variable Xⁱ and the threshold value O_{T}. After executing the second step S102 of finding the obstacle avoidance postures, proceed with the fourth step S104.

The third step S103: set parameters of each rotational axis and the telescopic axis which control an operation of the multi-axis robot arm 10. Set relevant parameters of each axis which controls the operation of the multi-axis robot arm 10 in sequence. In the third step S103 of setting the parameters, the set parameters of each rotational axis and the telescopic axis include a motor speed of each axis of the multi-axis robot arm 10, a motor speed of each connecting arm 12 of the multi-axis robot arm 10, a reduction ratio of a decelerator, a velocity percentage, acceleration time and deceleration time, etc. The third step S103 further has an action of getting needed time of an operation of each axis of the multi-axis robot arm 10 and each connecting arm 12 of the multi-axis robot arm 10 through the set parameters. After executing the third step S103, the host device 30 proceeds with the fourth step S104 together with the second step S102.

The fourth step S104: find the optimum obstacle avoidance posture, and select the optimum obstacle avoidance posture with the least time of the operation of the multi-axis robot arm 10 from the feasible obstacle avoidance postures. A plurality of feasible obstacle avoidance trajectories 112 are able to be obtained according to the aforesaid obstacle avoidance postures. The optimum obstacle avoidance postures are calculated according to the plurality of the obstacle avoidance trajectories 112 calculated in the second step S102. The fourth step S104 further has an action that calculates the optimum obstacle avoidance posture by means of the parameters of each axis to control the operation of the multi-axis robot arm 10 in the third step S103. The fourth step S104 further has an action of calculating operation time of each knuckle 11 and operation time of each connecting arm 12 which are based on the set parameters of each knuckle 11 and each connecting arm 12 for the plurality of the feasible obstacle avoidance trajectories 112. A running speed of each knuckle 11 and a running speed of each connecting arm 12 are able to be obtained through the set parameters, so that required time for an operation of each obstacle avoidance trajectory 112. The obstacle avoidance posture that takes the least time is selected as the optimum obstacle avoidance posture. The signal transmission module 33 transmits a control signal to the multi-axis robot arm 10 according to the optimum obstacle avoidance posture. Therefore, the multi-axis robot arm 10 is controlled to perform the optimum obstacle avoidance posture.

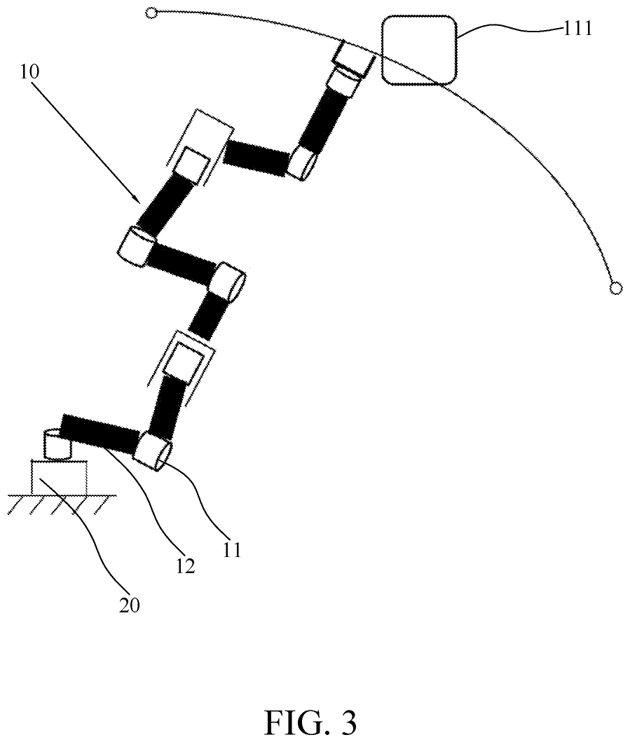

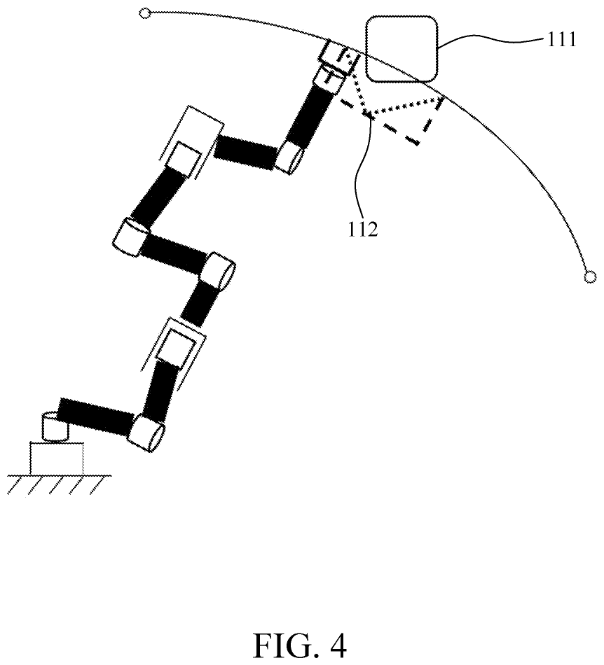

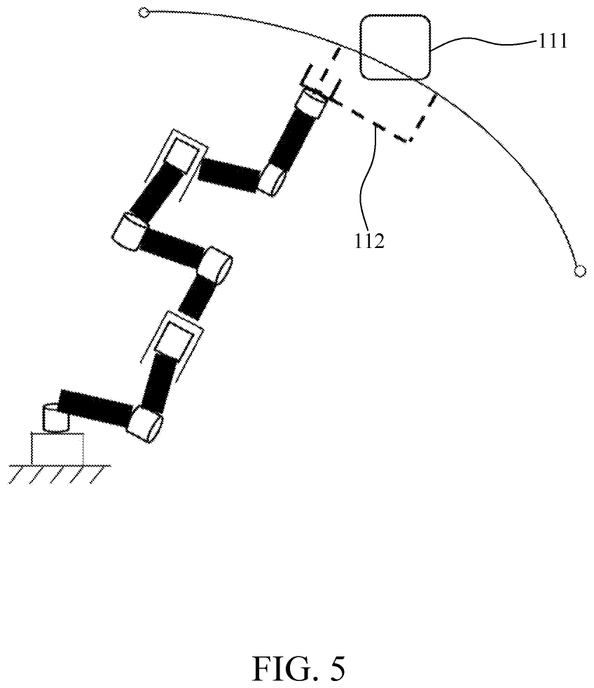

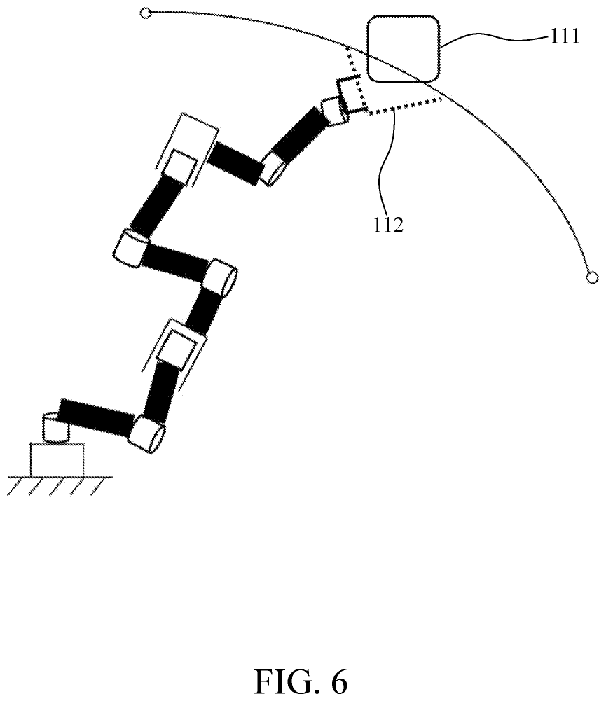

For example, the multi-axis robot arm 10 is an eight-axis robot arm. When the eight-axis robot arm executes a task along a specific path, the task is a two-point clamping and placement operation, a sudden obstacle 111 is suddenly invaded on the way of the path shown in FIG. 3. At the moment, the system 100 for the intelligent obstacle avoidance of multi-axis robot arm is activated, and several feasible obstacle avoidance trajectories 112 are planned in FIG. 4. When the telescopic axis is operated on account of the set parameters, needed time of executing the task of the telescopic axis is longer than other needed time of executing the task of other axes shown in FIG. 5. Therefore, choose the trajectory with the telescopic axis being fixed and the other axes having the smallest changing angles shown in FIG. 6. So that, the multi-axis robot arm 10 is able to complete the obstacle avoidance task with the optimum obstacle avoidance trajectory.

When the multi-axis robot arm 10 encounters the obstacle in the task execution process of the multi-axis robot arm 10, the multi-axis robot arm 10 will be not only without breaking off the task on account of encountering the obstacle, but also preferably optimize the obstacle avoidance trajectory and the obstacle avoidance postures through the set parameters, so that the task is able to be achieved more quickly.

The system 100 for the intelligent obstacle avoidance of multi-axis robot arm selects an optimum obstacle avoidance method by means of finding the obstacle avoidance postures according to the database of the database device 31 to calculate the feasible complex obstacle avoidance postures, setting the parameters and finding the optimum obstacle avoidance posture. The database is established to store the working posture data and the control variables of the multi-axis robot arm 10, the operation control module 32 calculates the feasible obstacle avoidance postures according to the database, the operation control module 32 sets the parameters of each of the plurality of the knuckles 11 and the connecting arms 12, the parameters control the operation of the multi-axis robot arm 10, the operation control module 32 selects the optimum obstacle avoidance posture with the least time of the operation of the multi-axis robot arm 10 from the feasible obstacle avoidance postures, and according to the optimum obstacle avoidance posture, the signal transmission module 33 transmits the control signal to the multi-axis robot arm 10 for performing the optimum obstacle avoidance posture.

When the method for the intelligent obstacle avoidance of multi-axis robot arm and the system 100 for the intelligent obstacle avoidance of multi-axis robot arm are able to be applied in another preferred embodiment of the present invention. The system 100 for the intelligent obstacle avoidance of multi-axis robot arm includes a robotic arm and the host device 30. The robotic arm is fixed on the pedestal 20. The robotic arm includes the plurality of the knuckles 11 and the plurality of the connecting arms 12. An electrical connection way between the host device 30 and the robotic arm is without being limited to the wireless signal transmission through the signal transmission module 33.

In the first step S101: the database of the database device 31 includes the working posture data, the control parameters of the robotic arm and the control variables of the robotic arm. The first step S101 further has an action of modularizing the robotic arm in the strict condition, so that the enough buffer space is formed between the robotic arm and the obstacle. The robotic arm has the various working postures in the various working ranges. The first step S101 further has the action of marking the various working postures in the various working ranges as the sampling points. The first step S101 further has an action of establishing a relative relationship between the evaluation coordinates and the working postures of the robotic arm through the multiple evaluation coordinates.

The first step S101 further has an action of obtaining the control parameters and the control variables of the working postures of the robotic arm on a trajectory of the robotic arm. The control variables and the control parameters are able to be directly set via the host device 30 which is the robot controller, or calculate the control variables and the control parameters which are corresponding to each axis of the robotic arm from the known working postures and according to the inverse kinematics. The first step S101 further has an action of judging whether the space coordinates within the working range of the robotic arm are occupied by the robotic arm. If the space coordinates within the working range of the robotic arm are occupied by the robotic arm, the robotic arm is judged to touch the obstacle, on the contrary, the robotic arm is without touching the obstacle. The first step S101 further has an action of establishing the above data in advance for the use of the subsequent obstacle avoidance.

In the second step S102, when the value of 0 T is smaller, a distance between the robotic arm and the obstacle is larger, and a probability of the robotic arm touching the obstacle is lowered. The obstacle avoidance postures of the robotic arm are able to be calculated.

In the third step S103: set a relevant parameter of each axis which controls an operation of the robotic arm in sequence.

In the fourth step S104: the robotic arm is able to complete the obstacle avoidance task with the optimum obstacle avoidance trajectory.

When the robotic arm encounters the obstacle in a task execution process of the robotic arm, the robotic arm will be not only without breaking off the task on account of encountering the obstacle, but also preferably optimize the obstacle avoidance trajectory and the obstacle avoidance postures through the set parameters.

As described above, the intelligent obstacle avoidance of multi-axis robot arm applies the method for the intelligent obstacle avoidance of multi-axis robot arm, and the system 100 for the intelligent obstacle avoidance of multi-axis robot arm applies the method for the intelligent obstacle avoidance of multi-axis robot arm, the system 100 for the intelligent obstacle avoidance of multi-axis robot arm pre-stores the possible postures of the multi-axis robot arm 10 in the database of the database device 31. When the multi-axis robot arm 10 is operated, whether a collision will occur is able to be quickly evaluated during a movement, so the method for the intelligent obstacle avoidance of multi-axis robot arm exactly reaches a purpose of the present invention. As a result, the intelligent obstacle avoidance of multi-axis robot arm is used to select the optimum obstacle avoidance method from a variety of obstacle avoidance methods.

A technical content disclosed by the present invention is without being limited to the above embodiment. If a content is the same as an invention concept and principle disclosed by the present invention, the content falls into an application patent scope of the present invention. Definitions of components are need be noticed, such as “first”, “second”, “third” and “fourth” are undefined words, but distinguishing words. Words “include” or “contain” which are used in the present invention, cover a containing concept and a having concept. and said the components, operating procedures and/or group or the combination of the above, does not mean to eliminate or increase, and denote a component, an operation step and a group, or denote the component, the operation step, the group or an above combination, an excluding meaning or an increasing meaning is without being represented. Unless a special description on “again”, otherwise, an operation step order is without representing an absolute order. Unless a special description on “more”, otherwise, when the component is referred in a singular form (such as using articles “a” or “one”) is without representing “the one and only one”, but “the one or more”. Words “and/or” which are used in the present invention refer to “and” or “or”, and “and” and “or”. Related scope terms which are used in the present invention contain all limitations and/or a range limitation, such as “at least”, “greater than”, “less than”, and “at most”, etc. Is refers to the range of the upper or lower limit, denote an upper limit or a lower limit of a scope.

Nevertheless, the above-mentioned description is just the embodiment of the present invention. When an implementing scope of the present invention is unable to be limited by the above-mentioned description, all simple equivalent changes and modifications in accordance with the application patent scope of the present invention and a patent specification content are still within a scope covered by a patent of the present invention

What is claimed is:

1. A method for an intelligent obstacle avoidance of multi-axis robot arm applied in a multi-axis robot arm, the multi-axis robot arm including a plurality of rotational axes and a telescopic axis, the method for the intelligent obstacle avoidance of multi-axis robot arm comprising steps of:
establishing a database, the database including working posture data and control variables of the multi-axis robot arm;
calculating feasible obstacle avoidance postures according to the database;
setting parameters of each rotational axis and the telescopic axis which control an operation of the multi-axis robot arm; and
selecting the optimum obstacle avoidance posture with the least time of the operation of the multi-axis robot arm from the feasible obstacle avoidance postures.

2. The method for the intelligent obstacle avoidance of multi-axis robot arm as claimed in claim 1, wherein the multi-axis robot arm has various working postures in various working ranges, the step of establishing the database has an action of marking the various working postures in the various working ranges as sampling points, each sampling point has an own evaluation coordinate, the step of establishing a database has an action of establishing a relative relationship between the evaluation coordinates and the working postures of the multi-axis robot arm.

3. The method for the intelligent obstacle avoidance of multi-axis robot arm as claimed in claim 1, wherein the method for the intelligent obstacle avoidance of multi-axis robot arm is applied in a host device, the host device is electrically connected with the multi-axis robot arm, the control variables are directly set via the host device which is a robot controller.

4. The method for the intelligent obstacle avoidance of multi-axis robot arm as claimed in claim 3, wherein the control variables are calculated, the control variables are corresponding to the rotational axes and the telescopic axis of the multi-axis robot arm from the known working postures and according to inverse kinematics.

5. The method for the intelligent obstacle avoidance of multi-axis robot arm as claimed in claim 1, wherein the parameters of each rotational axis and the telescopic axis include a motor speed of each axis of the multi-axis robot arm, a reduction ratio of a decelerator, a velocity percentage, acceleration time and deceleration time.

6. The method for the intelligent obstacle avoidance of multi-axis robot arm as claimed in claim 1, wherein the obstacle avoidance posture that takes the least time is the optimum obstacle avoidance posture.

7. The method for the intelligent obstacle avoidance of multi-axis robot arm as claimed in claim 1, wherein find the obstacle avoidance postures according to the step of establishing the database to calculate the feasible complex obstacle avoidance postures, and then select the optimum obstacle avoidance posture.

8. The method for the intelligent obstacle avoidance of multi-axis robot arm as claimed in claim 1, wherein set relevant parameters of each axis which controls the operation of the multi-axis robot arm.

9. The method for the intelligent obstacle avoidance of multi-axis robot arm as claimed in claim 1, wherein find the optimum obstacle avoidance posture, the optimum obstacle avoidance postures are calculated according to a plurality of obstacle avoidance trajectories, calculate the optimum obstacle avoidance posture by means of the parameters of each axis to control the operation of the multi-axis robot arm.

10. A system for an intelligent obstacle avoidance of multi-axis robot arm, comprising:
a multi-axis robot arm including a plurality of knuckles and a plurality of connecting arms, the plurality of the connecting arms being alternately connected with the plurality of the knuckles, the plurality of the connecting arms having a telescopic module; and
a host device electrically connected with the multi-axis robot arm, the host device including:
a database device;
an operation control module; and
a signal transmission module, the database device, the operation control module and the signal transmission module being electrically connected;
wherein the database is established to store working posture data and control variables of the multi-axis robot arm, the operation control module calculates feasible obstacle avoidance postures according to the database, the operation control module sets parameters of each of the knuckles and the connecting arms, the parameters control an operation of the multi-axis robot arm, the operation control module selects the optimum obstacle avoidance posture with the least time of the operation of the multi-axis robot arm from the feasible obstacle avoidance postures, and according to the optimum obstacle avoidance posture, the signal transmission module transmits a control signal to the multi-axis robot arm for performing the optimum obstacle avoidance posture.

11. A system for an intelligent obstacle avoidance of multi-axis robot arm, comprising:
a multi-axis robot arm including a plurality of knuckles and a plurality of connecting arms, the plurality of the connecting arms being alternately connected with the plurality of the knuckles; and
a host device electrically connected with the multi-axis robot arm, the host device including:
a database device;
an operation control module; and
a signal transmission module, the database device, the operation control module and the signal transmission module being electrically connected;
wherein when the multi-axis robot arm encounters an obstacle in a task execution process of the multi-axis robot arm, the multi-axis robot arm will be not only without breaking off a task on account of encountering the obstacle, but also preferably optimize an obstacle avoidance trajectory and obstacle avoidance postures, so that the task is able to be achieved more quickly.

12. The system for the intelligent obstacle avoidance of multi-axis robot arm as claimed in claim 11, wherein the multi-axis robot arm is an eight-axis robot arm.
